(19) United States
(12) Patent Application Publication
(10) Pub. No.: US 2025/0313485 A1
(43) Pub. Date: Oct. 9, 2025

(54) AEROGEL COMPOSITION FOR THERMAL INSULATION

(71) Applicant: Cabot Corporation, Boston, MA (US)

(72) Inventors: Xiaofeng Zhang, Shrewsbury, MA (US); Peter F. Pescatore, Wakefield, MA (US); Angelica M. Sanchez Garcia, Somerville, MA (US); Clare Bannon, Boston, MA (US)

(21) Appl. No.: 18/865,395

(22) PCT Filed: May 25, 2023
(86) PCT No.: PCT/US2023/023565

§ 371 Date: Nov. 13, 2024

Related U.S. Application Data
(60) Provisional application No. 63/346,409, filed on May 27, 2022.

(51) Int. Cl. C01B 33/158; C01B 33/18

(52) U.S. Cl. CPC C01B 33/1585; C01B 33/183; C01P 2006/32

(57) ABSTRACT

A heat control member comprises a mixture of a) silica aerogel particles having particle sizes in a range from 0.1 mm to 5 mm and b) hydrophobic silica-containing particles having a methanol number of at least 30 and a particle size D50 of 100 microns or less, the mixture having a particle size distribution of silica-containing particles having at least two peaks. The silica aerogel particles and hydrophobic silica containing particles are present in a ratio from 1:99 to 99:1; and the heat control member has a thermal conductivity at 25° C. of from 5 to 30 mW/m.K and a thickness of 0.1-10 mm.

### BACKGROUND OF THE INVENTION

### 1. Field of the Invention

This invention relates to an aerogel blend composition for thermal insulation, in particular, for multi-cell rechargeable batteries.

### 2. Description of the Related Art

Aerogel particles can have a very low density, high porosity, and small pore diameters. Aerogels, and in particular silica aerogels, exhibit low density and low thermal conductivity, making them useful as insulative materials. Aerogels can be formed by removing solvent from hydrogels, such as through supercritical drying techniques or via solvent substitution combined with ambient pressure drying. Silica aerogels are typically hydrophilic but can be rendered hydrophobic through the use of specific treating agents.

In the broadest sense, i.e., when regarded as “gels with air as the dispersant,” aerogels are manufactured by drying a suitable gel. When used in this sense, the term “aerogel” includes aerogels in the narrower sense, such as xerogels and cryogels. A gel is designated as an aerogel in the narrower sense if the liquid is removed from the gel at temperatures above the critical temperature and starting from pressures that are above the critical pressure. In contrast to this, if the liquid is removed from the gel sub-critically, for example with the formation of a liquid-vapor boundary phase, then the resulting gel is, in many instances, referred to as xerogel. It should be noted that the gels according to the present invention are aerogels in the sense that they are gels with air as the dispersing media.

Insulation articles are used in a variety of applications to provide an insulation layer. For example, insulation articles or heat control members, for example, in the form of panels or blankets, are used in applications including but not limited to architecture, refrigerators, materials handling (e.g., to insulate pipes), and rechargeable batteries. These insulation articles may employ aerogel and/or other particles to thwart thermal conductivity, inhibit thermal losses via infrared radiation, and provide other desirable properties. In addition, they may have additional components, such as glass fibers, to provide additional functions such as mechanical integrity and fire retardance.

The components of a heat control member that provide non-thermal insulation functionality reduce the degree of thermal insulation provided by the article. Thus, it is desirable to have a heat control member in which insulating particles are formulated to compensate for the effects of other components on thermal properties.

### SUMMARY OF THE INVENTION

A heat control member comprises a mixture of a) silica aerogel particles having particle sizes in a range from 0.1 mm to 5 mm and b) hydrophobic silica-containing particles having a methanol number of at least 30 and a particle size D50 of 100 microns or less, the mixture having a particle size distribution of silica-containing particles having at least two peaks. The silica aerogel particles and hydrophobic silica containing particles are present in a ratio from 1:99 to 99:1; and the heat control member has a thermal conductivity at 25° C. of from 5 to 30 mW/m. K and a maximum thickness of 10 mm.

The hydrophobic silica-containing particles may be selected from the group consisting of silica aerogel, fumed silica, silicon-treated carbon black, silica-coated carbon black, fumed mixed metal oxides, precipitated silica, silica-carbon black composite particles, rice-husk silica, and sol-gel silica. For example, the hydrophobic silica-containing particles may be selected from the group consisting of silica aerogel, fumed silica, and sol-gel silica. The hydrophobic silica-containing particles may be hydrophobized by a silicone fluid, a cyclic siloxane, a hydrophobizing silane, a functionalized silane, or a silazane. The hydrophobic silica-containing particles may be hydrophobic fumed silica particles having a surface area from 30 to 550 m²/g, preferably from 30 to 250 m²/g.

The hydrophobizing silane may be R₄₋ₙSiXₙ wherein n is 1-3, each R is independently selected from the group consisting of hydrogen, a C1-C30 branched and straight chain alkyl or alkenyl group, a C3-C18 haloalkyl group, C3-C10 cycloalkyl, and a C6-C14 aromatic group, and each X is independently a C1-C18 branched or straight chain alkoxy group or halo. The functionalized silane may include at least one functional group selected from the group consisting of acrylate, methacrylate, amino, anhydride, epoxy, halogen, hydroxyl, sulfur, vinyl, isocyanate, and combinations thereof. The particle size D50 of the hydrophobic silica-containing particle may be from 0.1 microns to 100 microns.

The mixture may further include fibers. The fibers may be glass fibers, ceramic fibers, synthetic polymer fibers, carbon fiber, natural polymer fibers, mineral wool, or a mixture of two or more of these. The fibers may be blackened or coated with a metal.

At least a portion of the silica aerogel present in the heat control member may incorporate an opacifier. At least a portion of the silica aerogel may be coated with or impregnated with a heat absorbing material. The mixture may further include one or more components selected from the group consisting of fiber, opacifier, fire retardant, heat absorbing material, phase change material, binder, defoamer, dispersant, emulsifier, surfactant, and flocculant.

The heat control member may further include a sheet or mat comprising silicone, polyvinylidene fluoride, chlorinated polyethylene, aramid fibers, or aramid aerogel. The heat control member may further include an envelope encapsulating the mixture. The heat control member may be in the form of a blanket or pressed pad. The heat control member may meet the specifications of UL94 V0.

It is to be understood that both the foregoing general description and the following detailed description are exemplary and explanatory only and are intended to provide further explanation of the present invention, as claimed.

### DETAILED DESCRIPTION OF THE INVENTION

A heat control member comprises a mixture of a) silica aerogel particles having particle sizes in a range from 0.1 mm to 5 mm and b) hydrophobic silica-containing particles having a methanol number of at least 30 and a particle size D50 of 100 microns or less. the mixture having a particle size distribution of silica-containing particles having at least two peaks. The silica aerogel particles and hydrophobic silica containing particles are present in a ratio from 1:99 to 99:1; and the heat control member has a thermal conductivity at 25° C. of from 5 to 30 mW/m. K and a maximum thickness of 10 mm.

Any type of silica aerogel particle(s) can be used in the mixture. Aerogels may be formed as described in U.S. Pat. No. 7,470,725. Suitable aerogels can be made from waterglass or from organic materials such as TEOS and TMOS. To reduce the radiative contribution to thermal conductivity, the aerogel particles can incorporate IR opacifiers, such as carbon black, alumina, graphite, titanium dioxide, iron oxide, silicon carbide, zirconium dioxide, or mixtures thereof. Aerogel particles are available from a variety of sources, including from Cabot Corporation under the ENOVA and ENTERA brands and from JIOS Aerogel under the AEROVA brand.

The silica aerogel of component a) can have particle sizes in a range from 0.1 mm to 5 mm, for example, from 0.1 mm to 4 mm, from 0.1 mm to 1.5 mm, from 0.5 mm to 4 mm, or from 1 mm to 4 mm. The aerogels can have narrow or wide particle size distributions and can be in the form of comminuted powders. Particle size may be measured by sieving.

A variety of hydrophobic silica aerogels can be used. Hydrophobic silica aerogels are those exhibiting a water contact angle of greater than 90 degrees. Examples include, but are not limited to, aerogels commercially available from Cabot Corporation. Particular commercially available types include, but are not limited to, ENOVA® brand aerogels, ENTERA brand aerogels, and P100 and P200 aerogels available from Cabot Corporation. As the aerogel is preferably pre-formed prior to the assembly of the aerogel-containing envelop. any desirable aerogel structure. morphology. or other characteristic can be chosen. and this characteristic can be essentially present in the final product. Aerogel particles are also be commercially available as mixtures with opacifiers such as carbon black.

In one set of embodiments, aerogel particles with porosities of greater than about 60% and densities of less than about 0.4 g/cc can be used. In other embodiments, aerogel particles may have densities of from about 0.05 to about 0.15 g/cc. The thermal conductivity of the aerogel particles can be less than about 40 mW/m.K, less than about 25 mW/m.K, or from about 12 mW/m.K to about 18 mW/m.K, or lower. To reduce flammability, for example, the aerogel particles may be low calorie aerogels, such as those having a caloric content of. for example, less than 10 MJ/kg, less than 8 MJ/kg, less than 7 MJ/kg or less than 6 MJ/kg. The aerogel particles may be present in an amount of 10 wt % to 90 wt % based on the total dry weight of the mixture. This amount can be from 20 wt % to 80 w1%, from 30 w1% to 70 w1%, from 40 w1% to 70 w1%. from 50 w1% to 90 w1%, from 60 wt % to 90 wt %, from 10 wt % to 30 wt %, from 10 wt % to 40 wt % or any range based upon any two values described herein.

The hydrophobic silica-containing particles may be a second silica aerogel or a hydrophobic silicon-treated carbon black, silica-coated carbon black, silica-carbon black composite particles, fumed silica, fumed mixed metal oxides, hydrophobic precipitated silica. rice husk silica, or sol-gel silica. Preferably, the hydrophobic silica-containing particle is a second silica aerogel or hydrophobic fumed silica. Hydrophobic silicon-treated carbon black, silica-coated carbon black, silica-carbon black composite particles, or titania-containing mixed metal oxides may be used to introduce infrared absorption capability to the heat control member. The methanol number of the hydrophobic silica-containing particles may be at least 30. for example, at least 35, at least 40, at least 50, at least 60, or at least 70, or from 35-80. Methanol number may be measured using Rhesca Wet-101P powder wettability tester (Rhesca Co. Ltd.) according to the manufacturer's instructions using a starting solution of 60 mL, a stir rate of 300 rpm, a methanol flow rate of 2 mL/min. The starting solution is degassed by stirring for at least 5 min at 1000 rpm prior to adding the sample. The measurement is typically run with 0.1 g of sample in a starting solution of 30% methanol. However, a more or less hydrophobic starting solution may be employed depending on the hydrophobicity of the sample. The test is run by titrating the starting solution with methanol: the methanol number is the amount of methanol in the solution when the sample, which is initially sitting on top of the starting solution. starts to wet into. or sink, into the solution, and may be calculated automatically by the instrument. Alternatively, a threshold methanol number of a powder may be determined by carefully pouring a sample onto the surface of a methanol-water solution having a known methanol concentration. If the sample does not wet into the solution, its methanol number is higher than the concentration of methanol in the solution.

The hydrophobic silica-containing particles have a smaller particle size than the silica aerogel, preferably a particle size D50 (volume basis) of 100 microns or less, for example, from 0.1 microns to 95 microns, from 1 microns to 90 microns, from 5 microns to 20 microns, from 10 microns to 30 microns, from 20 microns to 40 microns, or from 30 microns to 60 microns, from 40 microns to 70 microns, from 60 microns to 80 microns, or from 70 microns to 100 microns. For example, a second silica aerogel may be ground, classified, and/or comminuted to provide aerogel particles having a smaller size than the (first) silica aerogel particles. Exemplary silica aerogel particles for use as the second silica aerogel include but are not limited to TLD201 and TLD203 silica aerogel from Cabot Corporation. The silica aerogel particles and the hydrophobic silica-containing particles may be present in a mass ratio of from 1:99 to 99:1, for example, from 80:20 to 20:80, from 35:65 to 65:35, from 40:60 to 60:40, or from 45:65 to 65:45.

Where the hydrophobic silica-containing particles are a second silica aerogel, the aerogel may be the same or different type or composition of aerogel than the (first) silica aerogel, except that it should have a different particle size as discussed above. For example, the second silica aerogel may come from the same or different manufacturer or may have the same or different additives than the first aerogel.

Alternatively or in addition, the hydrophobic silica-containing particles may be hydrophobic fumed, or pyrogenic, silica. Fumed silica typically has a particle size from 2-20 nm and is formed from the vapor phase. In one manufacturing process, silica (usually sand) is vaporized at about 2000° C. and cooled to form anhydrous amorphous silica particles. Alternatively, silica can be sublimed at about 1500° C. in the presence of a reducing agent (e.g., coke) to form SiO, which can be oxidized to form particulate silica. Other methods of producing fumed silica include, for example, oxidation of SiCl₄ at high temperatures or burning SiCl₄ in the presence of methane or hydrogen.

A well-documented process for producing fumed metal oxides involves the hydrolysis of suitable feed stock vapor (such as aluminum chloride for a fumed alumina. or silicon tetrachloride for fumed silica) in a flame of hydrogen and oxygen. Molten particles of roughly spherical shape are formed in the combustion process, and the particle diameters may be varied through control of process parameters. These molten spheres, referred to as primary particles, fuse with one another by undergoing collisions at their contact points to form branched, three-dimensional chain-like aggregates. The formation of the aggregates is considered to be irreversible as a result of the fusion between the primary particles. During cooling and collecting, the aggregates undergo further collisions that may result in some mechanical entanglements to form agglomerates. These agglomerates are thought to be loosely held together by van der Waals forces and can be reversed, i.e., de-agglomerated, by proper dispersion in a suitable media or by milling, e.g., in a jet mill or hammer mill.

Alternative methods for producing pyrogenic silica particles have been developed, as described, for example. in U.S. Pat. Nos. 4,755,368, 6551567, and 6,702,994, US Patent Publication No. 20110244387, in Mueller, et al., “Nanoparticle synthesis at high production rates by flame spray pyrolysis,” Chemical Engineering Science, 58: 1969 (2003), in Naito, et al., “New Submicron Silica Produced by the Fumed Process,” published in NIP 28: International Conference on Digital Printing Technologies and Digital Fabrication 2012, 2012, p. 179-182, and in Kodas and Hampden-Smith, Aerosol Processing of Materials, Wiley-VCH, 1998, the contents of all of which are incorporated by reference. Other methods for preparing pyrogenic silica particles are known.

In some embodiments, pyrogenic silicas for use in the heat control members described herein have a BET surface area from 30 to 550 m²/g, such as. for instance, from 75 to 150, 150 to 250, 250 to 350, or 350 to 400 m²/g. Particle size of pyrogenic silica, as used herein, indicates the size of the agglomerate. This may be measured using a Malvern Mastersizer 3000 equipped with an Aero S dry powder accessory module. The sample is conveyed at a consistent rate into a compressed airstream operated at a compressed air feed pressure of 0.05MPa (0.5 bar) through which a laser beam is passed. An appropriate feed rate and laser obscuration are maintained throughout the analysis in order to achieve an acceptable signal to noise ratio providing reliable data. One of skill in the art will recognize that appropriate feed rate and laser obscuration may be different for different particulates. An appropriate obscuration for fumed silica is typically in a range from 0.4 and 3.0%. D50 for fumed silica is typically from 5 to 40 microns but can be smaller if the fumed silica is milled. Any hydrophobic fumed silica having D50 of 100 microns or less may be used.

Both hydrophilic fumed silicas that may be surface treated for use in the embodiments provided herein and hydrophobic fumed silicas are available commercially. Non-limiting examples of fumed silicas include CAB-O-SIL fumed silica available from Cabot Corporation. HDK fumed silica products available from Wacker Chemie AG, and AEROSIL fumed silica available from Evonik Industries, Essen, Germany.

Alternatively or in addition, silica-containing particles that also contain other materials may also be used. For example, silica-coated carbon black may be employed. Exemplary silica-coated carbon blacks include those described in U.S. Pat. Nos. 6,541,113, 6,197,274, and 9,598,560, the contents of all of which are incorporated herein by reference. Silicon-treated carbon black having a silica phase and a carbon phase may also be employed. Methods of making and surface treating various types of silicon-treated carbon blacks are described in U.S. Pat. Nos. 7,199,176; 6,709,506; 6,686,409; 6,534,569; 6,469,089; 6,448,309; 6,364,944; 6,323,273; 6,211,279; 6,169,129; 6.057,387; 6,028,137; 6,008,272; 5,977,213; 5,948,835; 5,919,841; 5,904,762; 5,877,238; 5,869,550; 5,863,323; 5,830,930; 5,749,950; 5,747,562; 5,622,557; and 6,929,783; and U.S. Published Patent Application No. 2002/0027110, all incorporated in this application, in their entirety by reference herein. Carbon black-silica composite particles such as those discussed in U.S. Pat. No. 10,800,925, the entire contents of which are incorporated herein by reference, may also be employed. Co-fumed silica particles such as silica-titania or silica-alumina mixed oxides may also be used. Exemplary hydrophilic and hydrophobic mixed oxides are disclosed in U.S. Pat. Nos. 5,424,258, 6,197,469, 7,083,769, US20100016490, US 20050239921, U.S. Pat. Nos. 6,328,944, 4,297,143, and 7,897,256. the entire contents of all of which are incorporated herein by reference. Any of these silica-containing materials that are not already hydrophobic may be surface treated in the same manner as fumed or precipitated silica as described below.

Precipitated metal oxide particles may be manufactured utilizing conventional techniques and are often formed by the coagulation of the desired particles from an aqueous medium under the influence of high salt concentrations, acids, or other coagulants. The metal oxide particles are filtered, washed, dried, and separated from residues of other reaction products by conventional techniques known to those skilled in the art. Precipitated particles are often aggregated in the sense that numerous primary particles coagulate to one another to form a somewhat spherical aggregated cluster. Non-limiting examples of commercially available precipitated metal oxides include Hi-Sil® products from PPG Industries, Inc. and SIPERNAT® products available from Degussa Corporation.

Sol-gel metal oxide particles, sometimes termed colloidal metal oxide particles, are often non-aggregated, individually discrete (primary) particles, which typically are spherical or nearly spherical in shape, but can have other shapes (e.g., shapes with generally elliptical, square, or rectangular cross-sections). Sol-gel metal oxides are commercially available or can be prepared by known methods from various starting materials (e.g., wet-process type metal oxides). Sol-gel metal oxide particles are typically fabricated in a manner similar to precipitated metal oxide particles (i.e., they are coagulated from an aqueous medium) but remain dispersed in a liquid medium (often water alone or with a co-solvent and/or stabilizing agent). Metal oxide particles can be prepared, for example, from silicic acid derived from an alkali silicate solution having a pH of about 9 to about 11, wherein the silicate anions undergo polymerization to produce discrete silica particles having the desired average particle size in the form of an aqueous dispersion. Typically, the metal oxide starting material will be available as a sol, which is a dispersion of the metal oxide in a suitable solvent, most often water alone or with a co-solvent and/or stabilizing agent. See, e.g., Stoeber, et al., “Controlled Growth of Monodisperse Silica Spheres in the Micron Size Range,” Journal of Colloid and Interface Science, 26, 1968, pp. 62-69, Akitoshi Yoshida. Silica Nucleation, Polymerization, and Growth Preparation of Monodispersed Sols, in Colloidal Silica Fundamentals and Applications, pp 47-56 (H. E. Bergna & W. O. Roberts, eds., CRC Press: Boca Raton, Florida, 2006), and Iler, R. K., The Chemistry of Silica, p 866 (John Wiley & Sons: New York, 1979). Non-limiting examples of commercially available sol-gel metal oxides suitable for use in the invention include SNOWTEX® products from Nissan Chemical, LUDOX® products available from W. R. Grace & Co., NexSil™M and NexSil A™ series products available from Nyacol Nanotechnologies, Inc., Quartron™ products available from Fuso Chemical, and Levasil® products available from AkzoNobel.

Sol-gel metal oxide particles may have a primary particle size from about 5 to about 100 nm, for example, from about 5 to about 10 nm, from about 10 to about 20 nm, from about 20 nm to about 30 nm. from about 30 to about 50 nm, or from about 50 to about 70 nm. The metal oxide particles may be spherical or non-spherical. For example. the aspect ratio of the metal oxide particles may be from about 1.5 to about 3, for example, from about 1.5 to about 1.8, from about 1.8 to about 2.1, from about 2.1 to about 2.5, from about 2.5 to about 2.8, or from about 2.8 to about 3. Particle size may be measured by dynamic light scattering.

Hydrophobic rice husk silica may also be used. Rice husk silica is derived from rice husks and may be produced via acid extraction followed by combustion, precipitation, or sol-gel methods. The hydrophobic rice husk silica may be in the form of an aerogel as described in CN101348255, EP1689676, or WO2022117618. Hydrophobic rice husk silica may also be prepared by the methods described in CN102583403 or CN1880384, by calcining, or via other methods known to those of skill in the art.

In certain embodiments, the hydrophobic silica-containing particle may be produced by treating hydrophilic particulate silica, e.g., fumed silica, precipitated silica, or sol-gel silica, with a surface treating agent known to one of skill in the art. Silica treating agents can be any suitable silica treating agent and can be covalently bonded to the surface of the silica particles or can be present as a non-covalently bonded coating. Typically, the silica treating agent is bonded either covalently or non-covalently to silica. In many cases, the silica treating agent can be a silicone fluid, for example a non-functionalized silicone fluid or a functionalized silicone fluid, a cyclic siloxane, hydrophobizing silanes, functionalized silanes, silazanes or other silica treating agents, e.g., as known in the art.

In certain embodiments, the silica-treating agent comprises a hydrophobizing silane. For example, the silica-treating agent can be a compound of the formula: R₄₋ₙSiXₙ, where n is 1-3, each R is independently selected from the group consisting of hydrogen, a C1-C30 branched and straight chain alkyl or alkenyl group, a C3-C18 haloalkyl group. C3-C10 cycloalkyl, and a C6-C14 aromatic group, and each X is independently a C1-C18 branched or straight chain alkoxy group or halo. In certain embodiments, the silica-treating agent comprises a functionalized silane. The functionalized silane can comprise at least one functional group selected from the group consisting of acrylate, methacrylate, amino, anhydride, epoxy, halogen, hydroxyl, sulfur, vinyl, isocyanate, and combinations thereof. In certain embodiments, the silica-treating agent comprises a silazane, for example, the silica-treating agent can be hexamethyldisilazane, octamethyltrisilazane, a cyclic silazane such as those disclosed in U.S. Pat. No. 5,989,768, and the like. Treatment of fumed silicas also can effect a reversal of the charge on the particles. e.g., from negative to positive. Preferred hydrophobic treating agents for silicas for use as the hydrophobic silica-containing particles in various embodiments herein include hexamethyldisilazane, alkyltrialkoxysilanes and alkyldialkoxysilanes such as octamethyltrimethoxysilane, hexamethyldisiloxane, dimethyldichlorosilane, and siloxane compounds including but not limited to cyclic siloxanes, silicone fluids, and siloxane polymers including polydimethylsiloxane and functionalized siloxane polymers such as mono- and di-functional hydroxyl-terminated PDMS and dimethylsiloxane co-polymers including methylhydrosiloxane and/or methylhydroxylsiloxane mers.

Hydrophilic particulate silica may be surface treated using any suitable method known to those of skill in the art. For example, sol-gel silicas may be surface treated using techniques such as those described in U.S. Pat. Nos. 7,811,540, 8,202,502, 8,435,474, 8,455,165, 10,407,571, and 8,895,145, the contents of all of which are incorporated by reference. Dry silica particles may be surface treated using wet or dry techniques known to those of skill in the art. For example, a dry treatment method may include stirring or mixing the metal oxide and the hydrophobizing agent in a fluidized bed reactor. Alternatively, a wet treatment method may include dispersing the metal oxide into a solvent to form a metal oxide slurry, and adding the hydrophobizing agent to the slurry to thereby modify the metal oxide surface with the hydrophobizing agent. In addition, the charge-modified metal oxide may be prepared utilizing a batch or continuous process wherein the dry metal oxide is contacted with a liquid or vapor hydrophobizing agent with sufficient mixing. In a preferred embodiment, the mixture is then held for a period of time at a temperature sufficient to modify the surface of the properties of the metal oxide.

The mixture of silica aerogel and hydrophobic silica-containing particles may be used in conjunction or combination with one or more types of fiber. Fibers can provide strength and mechanical resilience, can reduce flammability, and can help to prevent the particles from settling after installation. The fibers can be natural fibers, synthetic fibers, or both. Glass fibers and ceramic fibers may be used. Fibers may be of consistent length or may include fibers of mixed length.

Glass and ceramic fibers that can be used in the various embodiments herein may be comprised of a variety of inorganic oxides, such as SiO₂, A₂O₃, B₂O₃, Na₂O, K₂O, CaO and MgO. Specific fibers may include one, two, three, four or more of these oxides. In some embodiments. fibers may be glass fibers such as borosilicate (B Fiber) and calcium aluminoborosilicate (E Fiber), which can be obtained, for example, from Lauscha Fiber International: and/or fibers that consist essentially of silica (Q fibers), which can be obtained, for example, from Johns Manville. Other types of fibers that can be used in certain embodiments include but are not limited to synthetically made non-carbon fiber, mineral wool, wollastonite, carbon fiber, ceramic, cellulose, cotton, polyvinyl alcohol (PVA), polybenzimidazole, polyaramid, acrylic, phenolic, polypropylene, other types of polyolefins, or organic fibers, such as aramid fibers, nylon fibers, or thermoplastic fibers. The fibers can also be coated, such as polyester fibers metallized with a metal such as aluminum. Mixtures of two or more types of fibers may also be employed.

The length and diameter of the fibers can vary with specific applications. In some embodiments, two or more different types of fiber can be used so that the length distribution of fibers exhibits a bimodal or multimodal distribution. Fiber lengths may range from 0.5 cm to 50 cm in length or longer, e.g., 0.5 to 2 cm, 1 to 15 cm, or 0.5 to 5 cm. The fibers may have a thickness from 1 nm or less to 1 mm or more, for example, from 1 nm to 100 nm, from 100 nm to 1000 nm, from 1 micron to 10 microns, from 10 microns to 50 microns, or from 50 microns to 1 mm. It is understood that the fibers may not be uniform in diameter. The aspect ratio (length:diameter) of the fibers may be at least 100:1, for example, 1000:1 to 10000:1. The fibers may be in any configuration known to those of skill in the art. For example the fibers may be in the form of chopped fiber, microfibers, woven fibers, or non-woven fibers.

The fibers can have any shape in cross section. The fibers can be round, polygonal, trilobal, pentalobal, octalobal, in the form of strips, or be shaped like fir trees, dumb bells, or otherwise. Fibers may have consistent or varying diameters along the length of the fiber. Hollow fibers can be used in some embodiments. Additionally, the fiber materials can be smooth or crimped and may be curled or straight. In certain embodiments the fibers can be modified by additives; for example, anti-static agents such as carbon black. The fibers can also contain IR opacifiers, such as carbon black, titanium dioxide, alumina, iron oxide, or zirconium dioxide, silicon carbide, as well as mixtures of these, in order to reduce the radiation contribution to thermal conductivity.

In addition to including IR opacifiers, the radiation contribution to the thermal conductivity can be further reduced by using blackened fibers, such as polyester fibers blackened with carbon black or simply carbon fibers. The mechanical strength of the heat control member can also be influenced by the length and distribution of the fibers in the composition. In order to reduce the increase in thermal conductivity caused by the added fibers, the proportion (by weight) of the fibers can be maintained at the lowest concentration required to achieve the desired mechanical strength. The amount of fiber used depends on its density, diameter, length and can be from 1% to 99% with respect to the total components of the heat control member, for example, 5% to 95%, 10% to 90%, 20%- 30%, 30%- 40%, 40%- 50%, 50%- 60%, 60%- 70%, 70%- 80%, or 80%- 90%. In certain embodiments, fibers may comprise, by weight, greater than 1%, greater than 3%, greater than 5% or greater than 10% of the heat control member. In other embodiments, fibers may account for less than 5%, less than 3% or less than 1% of the weight of the heat control member. The thermal conductivity of the fibers can be from about 0.01 to about 1 W/m.K and, preferably, less than about 1 W/m.K

Alternatively or in addition, opacifiers, such as infrared opacifiers, can be used in conjunction or combination with the mixture to reduce radiative heat transfer. IR opacifiers are materials that reduce the transmission of infrared radiation and include, for example, carbon black, mica, alumina, graphite, titanium dioxide, rutile sand, iron oxide, silicon carbide (SiC), graphite or zirconium dioxide. Different types of suitable titanium dioxide include, for example, Tipure® (DuPont) and Altiris® (Huntsman). IR opacifiers may be used individually or as mixtures of two or more compounds. IR opacifiers can be added in amounts that provide a target level of IR transmission reduction in the heat control member. These levels may be, for example, from 2% to 150%, 5% to 100% or 10% to 40% opacifier based on the weight of the mixture of silica aerogel and hydrophobic silica-containing particles. Two or more different average particle sizes and/or compositions opacifiers may be used in a single embodiment to cover a broader range of IR wavelengths.

In some embodiments, the heat control member can include a flame or fire retardant. Concentrations of fire and/or flame retardant in some embodiments may range, by weight, from 0.1% to 5.0%, 0.2% to 2.0%, and 0.3% to 1.5% with respect to the mass of the heat control member. Flame retardants may be, for example, alkali oxides, alkali earth metal oxides, aluminum trihydrate, magnesium hydroxide, antimony oxides, titanium dioxide, rutile sand. melamine compounds, phosphate based or halogen based compounds. In specific embodiments, titanium dioxide particles may have a diameter of about 1.18 μm, from 0.9 to 1.3 μm, from 0.8 to 1.4 μm or from 0.5 to 4.0 μm, and in certain embodiments the particle size distribution may have a d50 of about 1.0 μm+/−0.01 μm, +/−0.02 μm or +/−0.05 μm. Halogenated flame retardants include, for example, brominated flame retardants (BFR) such as organobromide compounds including polymeric organobromide compounds. In another set of embodiments, the flame retardant has a structure with a high ratio of heteroatoms to carbon atoms. For example, in some embodiments the ratio of heteroatoms to carbon atoms may be greater than 0.5 to 1, greater than 1 to 1, or greater than 2 to 1, and in specific embodiments the heteroatoms may be nitrogen and/or sulfur. Flame and/or fire retardants can be incorporated into the heat control member in concentrations adequate to suppress flammability or to meet specifications such as UL94-V0. Alternatively or in addition, embodiments of heat control members may exhibit caloric content of, for example, less than 10 MJ/kg, less than 8 MJ/kg, less than 5 MJ/kg, less than 3 MJ/kg, less than 2 MJ/kg, or less than 1 MJ/kg, for example, from 0.5 MJ/kg or 1 MJ/kg to 5 MJ/kg. The flame or fire retardant may be incorporated in the mixture of silica aerogel and hydrophobic-silica containing particles.

Alternatively or in addition, the heat control member may further include heat absorbing materials. Such materials help the heat control member behave not only as an insulator, retarding heat transfer, but as a heat capacitor which can store thermal energy. Such heat absorbing materials may include aluminum hydroxide and others known to those of skill in the art. Alternatively or in addition, heat absorbing materials may include phase change materials that store heat by undergoing a thermodynamic phase transformation. Heat absorbing materials may be incorporated in the mixture of silica aerogel and hydrophobic-silica containing particles or may be deposited on the surface of or otherwise impregnated into the pores of aerogel particles in the mixture.

Alternatively or in addition, the heat control member may include an additional sheet-like material to enhance mechanical integrity, heat resistance, mechanical resilience, and/or other properties. Examples include but are not limited to silicone-based materials, polyvinylidene fluoride, chlorinated polyethylene, aramid materials such as Kevlar (e.g., woven mats of aramid fibers), and Kevlar nanofiber aerogels such as those described in Lyu, et al., ACS Nano 2019, 13, 2236-2245. Woven mats of Kevlar or other aramid fibers may be impregnated with a shear thickening fluid such as those described in U.S. Pat. No. 7,825,045, the contents of which are incorporated herein by reference.

Alternatively or in addition, the mixture of silica aerogel and hydrophobic silica-containing particles may further include a binder. Suitable binders include silicone, polyvinyl alcohol, polyvinylidene fluoride, polyethylene terephthalate, polybutylene terephthalate, acrylate polymers, and other heat resistant and/or flame retardant polymers known to those of skill in the art. The binder can help prevent widespread dispersion or dissipation of the silica aerogel, hydrophobic silica-containing particles, and other particulate components of the heat control member in case of a catastrophic failure or explosion of the item being insulated, e.g., a battery. Binders such as polyvinyl alcohol can also bind additives such as carbon black to aerogel particles to alleviate dusting during assembly. Binders may be mixed with a portion or all the components of the mixture, including any additives incorporated into the mixture, using an impeller or other suitable apparatus known to those of skill in the art. Preferably, the binder does not render the aerogel blanket flammable under UL94 or other flammability test methods.

Alternatively or in addition, the mixture of silica aerogel and hydrophobic silica-containing particles may further include processing aids. Appropriate processing aids will depend on the manufacturing method and form of the heat control member. Suitable processing aids include but are not limited to defoamers, surfactants, dispersants, and emulsifiers.

In some embodiments, the mixture is encapsulated in an envelope. The envelope may serve to prevent dusting. help maintain the shape of the heat control member, facilitate manipulation or installation of the heat control member, and/or serve other useful functions known to those of skill in the art. The material that forms the envelope is preferably a flame retardant and/or heat resistant polymer. Exemplary polymers include silicones, polyvinylidene fluoride (PVDF), chlorinated polyethylene, and other similar polymers known to those of skill in the art. Alternatively or in addition, the material for the envelope may include a reinforcing fiber such as an aramid fiber to provide puncture resistance. A reinforcing material may be used in combination with other polymers or the envelope may be formed entirely of such polymers, e.g., a woven cloth of aramid fiber.

The heat control article may take any form known to those of skill in the art. For example, a fiber-containing blanket or pad may be made using techniques such as those described in, e.g., U.S. Pat. No. 9,399,864, US 20210363699, WO2022024085, CN112759353, U.S. Pat. No. 11,274,044, CN112681009, CN113943171, CN110093783, CN112681009, JP2015048543, and/or US 20200295328. the contents of all of which are incorporated herein by reference. In one embodiment, such as described in U.S. Pat. No. 9,399,864, an aqueous slurry is prepared with the mixture of silica aerogel, hydrophobic silica-containing particles, glass fibers, and other desired components (e.g., binders, opacifiers, fire retardants, defoamers, etc.) of the blanket or pad. A charged compound or other emulsifier or dispersant is added to the slurry to create an emulsion, which is then coagulated with a flocculating agent. The resulting floc is collected on a scrim or belt and dewatered. Air laying processes, wherein the silica aerogel, hydrophobic silica-containing particles, fibers, and other desired components (e.g., opacifiers, fire retardants, etc.) are combined with air and then deposited on an air permeable scrim, may also be used. In these embodiments, the fiber may be a polymer fiber that can melt to hold the blanket or pad together, or a silicone or other binder may be sprayed or otherwise deposited on one or both sides of the blanket or pad and activated under heat to hold the components together. Exemplary air laying methods that may be adapted to produce blankets or pads according to the embodiments herein include but are not limited to those disclosed in U.S. Pat. No. 4,083,913, US2004192136, and U.S. Pat. No. 6,479,416, the contents of which are incorporated herein by reference.

In another embodiment, the mixture, a binder, and any other desired components such as glass fibers are charged into a mold and pressed into a pad, for example, as described in EP3835262, the entire contents of which are incorporated by reference herein. It may be necessary to heat or otherwise activate a polymeric binder in the mold. Alternatively or in addition, the mixture, binder, and other components may be formulated into a paste and extruded, for example, as in EP3835262 and WO2020228998, the entire contents of which are incorporated herein by reference. Alternatively or in addition, the mixture may be incorporated into or combined with a polymer foam, such as described in WO2020211320, JP2020019925, and/or U.S. Pat. No. 10,640,629, the entire contents of all of which are incorporated herein by reference.

Alternatively, the mixture and any other desired components are used to fill an envelope or other cavity using techniques such as those described in CN113785431, CN110544809, JP2012145204, and/or US20210332932, the contents of all of which are incorporated herein by reference. Another suitable technique is to charge the mixture into an envelope or bag retained in an appropriately spaced mold. The mold is compressed by hand, e.g., using clamps, and then preferably evacuated. For thinner envelopes, it may be desirable to use a smaller diameter aerogel to facilitate free flow throughout the bag. Alternatively, the mass of material needed to produce a desired mass density in an envelope or pouch having a particular volume may simply be charged into the envelope without the use of a mold. The envelope may then be compressed with a roller to evenly distribute the mixture throughout the bag. In a preferred embodiment, a film or sheet, e.g., of polyethylene terephthalate or silicone, is laid in a mold on a vibration table and the mixture charged into the mold having a cavity, with a portion of the film or sheet overhanging beyond the cavity. The mold is vibrated and compressed with a plate at 8-12 psi to pack the mixture. A top sheet (or film) large enough to cover the cavity and the overhanging portions is laid on top and the overhanging portion sealed with the top sheet on three sides. Air is evacuated from the resulting envelope and the fourth side is sealed. Indeed, certain components, such as fibers and binders, may not be necessary if the envelope provides desired mechanical support. Indeed, in some embodiments it may be desirable only to have aerogel along with any optional opacifier and/or hydrophobic silica containing particles in the envelope.

The heat control member may be fabricated in roughly planar or flat form for insertion between cells of a rechargeable battery, e.g., a lithium ion battery. An evacuated envelope can be slightly thinner than the space in which it will be installed. Once installed, the envelope can be poked to release the vacuum and will expand until it is under compression. As the battery expands and contracts, the heat control member would also be free to expand and contract. Alternatively or in addition, the envelope need not be fabricated as a flat or sheet-like object but may be fabricated in a particular shape. For example, the heat control article may be shaped to be disposed about a particular component in a battery or other device and may have a more complicated shape.

In some embodiments, the heat control article includes an additional sheet-like material to enhance mechanical integrity, heat resistance, mechanical resilience, and/or other properties. Examples include but are not limited to silicone-based materials, polyvinylidene fluoride, chlorinated polyethylene, aramid materials such as Kevlar (e.g., woven mats of aramid fibers), and Kevlar nanofiber aerogels such as those described in Lyu, et al., ACS Nano 2019, 13, 2236-2245. Woven mats of Kevlar or other aramid fibers may be impregnated with a shear thickening fluid such as those described in U.S. Pat. No. 7,825,045, the contents of which are incorporated herein by reference.

An envelope can be used in some cases, serving to prevent dusting, help maintain the shape of the heat control article, facilitate its manipulation or installation, and so forth. The material that forms the envelope is preferably a flame retardant and/or heat resistant polymeric material, including, for instance, silicones, polyvinylidene fluoride (PVDF), chlorinated polyethylene, and other similar polymers known to those of skill in the art. Alternatively, or in addition, the material for the envelope may include a reinforcing fiber such as an aramid fiber to provide puncture resistance. A reinforcing material may be used in combination with other polymers or the envelope may be formed entirely of such polymers, e.g., a woven cloth of aramid fiber.

The heat control member may have a thickness of 0.1 to 10 mm, for example, from 0.5-8 mm, from 1 to 5 mm, or from 1.5 to 3 mm. In some embodiments, at least a portion of the components are compressed during assembly of the heat control member, for example, between rollers or platens, to reduce the thickness of the final article.

The heat control member may exhibit excellent thermal stability. For example, the heat control member may shrink less than 2% after aging at 650° C. according to ASTM-C356. The heat control member may have a thermal conductivity at 25° C. of less than 30 mW/m.K, preferably less than 25 mW/m.K, more preferably less than 20 mW/m.K, for example, from 5 mW/m.K to 20 mW/m.K or from 8 mW/m.K to 15 mW/m.K or from 15 mW/m.K to 25 mW/m.K according to test method ASTM C518.

The heat control article can be flexible, a property that may be measured according to ASTM C1101 or another suitable technique. Manual bending tests can be useful, especially at the initial screening stages of a product.

In specific implementations the heat control article is a blanket having a flammability rating of non-flammable according to UL94-V0.

The present invention will be further clarified by the following examples which are intended to be only exemplary in nature.

EXAMPLES

### Example 1

Vacuum bags (VAC-Master) were cut and resealed using an impulse sealer to form bags defining square openings of 8 inches×8 inches. Insulating pads were prepared by combining the components listed in Table 1 in either a Flacktek DAC600 Speedmixer (formulations without glass fiber) or at high speed in a stainless steel Waring blender (formulations with glass fiber). The glass fibers were 6 mm E-glass chopped fibers having a diameter of 6 microns from Lauscha Fiber International. A total of 10.53 g of material was used in each pad; any mixtures were a 50/50 mix by mass. The various particles are described in Table 2 below and come from Cabot Corporation: all have trimethylsilyl groups on the surface. The resulting mixture was spread evenly into the resized vacuum bag with a spatula until the thickness of the bag reached the thickness indicated in Table 1. Air was removed from the bag and the open edge of the bag was sealed with a VAC-Master VP320 according to the manufacturer's directions with the vacuum time set to 20 s, the sealing time set to 1.2 s, and the cooling time set to 2 s. Thermal conductivity and thickness were measured with a Lasercomp™ FOX200 (Waters/TA Instruments) according to ASTM C518. “Vacuum” indicates a measurement at 25° C. (15° C. cold side and 35° C. warm side) on the sample as prepared and compressed between two plates at a pressure of about 1 psi. “Popped” means a hole punctured in the bag to allow air to penetrate the bag. However, the compression on the sample was not released, limiting the amount of air that could enter the bag and increasing the pressure to over 1 psi. “No vacuum” means the compression on the bag was partially relieved following “popping”, allowing air pressure to equalize inside the bag and leaving the bag compressed at a pressure of about 1 psi.

TABLE 1

| | | Thermal conductivity at 25° C., | | |
|---|---|---|---|---|
| | | mW/m · K (Pad thickness, mm) | | |
| | | Vacuum, | No Vacuum, | No Vacuum, |
| | Insulation | 1 psi | 1 psi | no |
| Sample | materials | compression | compression | compression |
| 1 | P101/glass fiber | 15.07 (2.51) | 17.73 (2.41) | 22.36 (4.41) |
| 2 | Fumed silica/glass | 17.04 (2.13) | 22.20 (2.03) | 24.35(2.92) |
| | fiber | | | |
| 3 | P300/glass fiber | 20.68 (2.92) | 21.82 (3.32) | 26.24 (5.99) |
| 4 | P200/glass fiber | 17.91 (2.28) | 19.68 (2.15) | 22.62 (3.02) |
| 5 | P300 | 16.25 (2.92) | 17.45 (4.39) | 19.84 (5.28) |
| 6 | TLD203 | 16.78 (3.88) | 17.53 (3.93) | 18.69 (3.93) |
| 7 | P200 | 15.4 (3.53) | 17.12 (4.11) | 18.54 (4.67) |
| 8 | P300/TLD203 | 13.04 (3.07) | | |
| 9 | P200/TLD203 | 13.82 (3.32) | 15.03 (3.88) | 16.85 (4.24) |
| 10 | P200/Fumed silica | 9.32 (2.94) | 15.39 (2.81) | 17.90 (3.55) |
| 11 | Fumed silica | 18.46 (3.17) | 18.54 (3.25) | 19.23 (3.50) |

TABLE 2

| Particle name | Particle Type | Particle size |
|---|---|---|
| P101 | Aerogel, with 3 wt % | Range of 0.1-4.0 mm |
| | carbon black opacifier | |
| P300 | Aerogel | Range of 1.2-4.0 mm |
| P200 | Aerogel | Range of 0.1-1.2 mm |
| TLD203 | Aerogel | D50 = 80 μm |
| Fumed silica | CAB-O-SIL TS-530 with | D50 = 12-13 μm |
| | surface trimethylsilyl | |
| | groups, methanol | |
| | wettability = 63-64 | |

### Example 2

Nonwoven blankets containing aerogel particles and a combination of different particles (Table 3), were produced in a wet laid process as described below. Barlox 12 dispersant (45 ml), Nalco 7768 rheology modifier (135 ml) and Foam kill 830F defoamer (15 ml) were dispersed in 75 L of water to form process water. 3.8g 6 micron diameter micro fiberglass (Johns Manville), 1.0g ¼″ chopped fiberglass and 15.6g Novacryl PSR 300 binder, the aerogel, silica, and opacifiers in Table 3 were added to a WARING heavy duty blender. Approximately 1 L of process water as prepared above was added to the blender. The mixture in the blender was mixed for 30 sec at high shear (2000 rpm) to form a slurry, which was then transferred to a fifteen gallon slurry tank which was filled with 28 L of the process water. To destabilize the slurry system, 2 drops (10 ml) of Percol flocculant was added to the slurry to produce flocs. After flocculation, a drain at the bottom of the slurry tank was opened, allowing the supernatant to drain through a scrim. The flocs were retained by the scrim and was evenly distributed across it. The scrim was then passed over vacuum to remove additional water from the aerogel floc. Example 2A was passed through a roll press to reduce the blanket thickness. All blankets were placed in a drying oven at 170° C. for about 30 min.

TABLE 3
Wet laid nonwoven blanket containing aerogel particles

| | 2A | 2B | 2C | 2D |
|---|---|---|---|---|
| P200 Aerogel (g) | 13.4 | 13.4 | 10 | 10 |
| TLD203 aerogel (g) | 0 | 0 | 3.4 | 0 |
| Fumed silica (g) | 0 | 0 | 0 | 3.4 |
| Rutile Opacifier (g) | 3.2 | 6.0 | 6.0 | 6.0 |
| SiC Opacifier (g) | 3.0 | 0 | 0 | 0 |
| Pressed sample | Yes | No | No | No |
| Final Thickness (mm) | 0.93 | 2.13 | 2.41 | 2.46 |
| Thermal Conductivity, | 20.56 | 22.86 | 23.41 | 24.78 |
| 25° C. (mW/m · K) | | | | |

### Example 3

A bag (VacMaster Vacuum Chamber Pouch, approximately 150 mm×200 mm with 3 mil (0.76 mm) thick walls) open at one end was placed in a mold having a 5 mm gap. The mold was prepared by clamping two pieces of ¾″ (19 mm) plywood, each about 9.5″ (24.1 cm) square together with spacers (two paint stirrers) on either side to create an appropriately sized cavity. ENTERA EV5200 aerogel was charged into the bag, with vibration and tamping of the mold used to ensure complete filling of the bag. The filled bag was compressed by hand under approximately 5 psi load and then evacuated using a Vacmaster VP320 meat packer until about 90% vacuum was achieved. The evacuated pouch had a particle density of about 110 kg/m3. Thermal conductivity and thickness were measured as described above and were 15.96 mW/m.K and 6 mm.

### Example 4

The same design of bag as in Example 3 was filled with a predetermined weight of ENTERA EV5200 aerogel. The desired weight was that which is needed to achieve an end density of 110 kg/m³ in a 150 mm×200 mm×4 mm pouch. The bag was then compressed by hand under a roller using two rails to maintain the desired thickness of the filled bag at about 5 mm. The roller was rolled back and forth until the aerogel appeared to be evenly dispersed. The pack was then placed in the Vacmaster VP320 meat packer, evacuated, and then tested for thermal conductivity and thickness in the same manner as Example 1. Initial thickness in was 3.8 mm initially and rose to 4.1 mm after the vacuum had been released. The thermal conductivity was measured to be 16.30 mW/m.K.

### Example 5

Dispersant (Jeffamine M2070 dispersant, Huntsman), Nalclear 71605 rheology modifier (Nalco) and Foamkill™ 830 defoamer (Crucible Chemical) were dispersed in water to form a two liter white (process) aqueous concentrate in a WARING benchtop heavy duty blender, according to the formulations in Table 5. Mixing was conducted for 10 sec at high shear to form process water. Ceramic fiber (Fiberfrax® 7001 C5 ceramic fiber, Unifrax, a high purity coarsely chopped product having an average fiber diameter of 1.5 to 2.5 microns, and a fiber index of 45-55% measured by conical elutriation), P200 aerogel particles (Cabot Corporation), fumed silica (as indicated in Table 4, all CAB-O-SIL brand from Cabot Corporation; properties in Table 4, all with D50 from 5 to 20 microns), 44 micron rutile titania sand (Loudwolf), F600 6 micron silicon carbide (Sturbridge Metallurgical Services), and aluminum trihydroxide (ATH, Sigma Aldrich), were added to the WARING heavy duty blender in the quantities listed in Table 5. The mixture in the blender was mixed for 20 sec at high shear (15000 rpm) to form a paste-like dispersion. Acrylic binder (Novacryl PSR 300, Synthomer) and silicone binder (Dowsil HV 496 resin, Dow) were added to the blender and mixed for another 20 sec at high shear to make a slurry. To destabilize the slurry system, a flocculant (poly diallyldimethylammonium chloride (PDADMAC), 30% solution from Sigma Aldrich) was added to the slurry to produce flocs. Typically, an amount of 4 to 5 grams flocculant (as indicated in Table 5) was added to the dispersion until a dense flocculant layer formed at the top.

After flocculation, the slurry was drained through a single layer wet-lay forming wire to produce a 30 cm×30 cm blanket sheet. The blanket and forming wire were then passed over vacuum to remove additional water from the aerogel floc. Samples were passed through a roll press to squeeze out some of the water and compress the various components into a more compact form. All blankets were placed in a drying oven at 120° C. for about 20 min.

The blankets were evaluated for several properties. Thermal conductivity and thickness were measured using a LaserComp Heat Flow Meter instrument according to ASTM C518. Samples were also evaluated under the UL94 flammability standard. Results are in Table 6 and show that surface treatment can provide an improvement in thermal conductivity performance and do not impair flammability performance.

TABLE 4

| | | Nitrogen Surface | Methanol |
|---|---|---|---|
| Silica type | Surface treatment | Area (m²/g) | wettability (%) |
| TS-530 | Hexamethyldisilazane | 215 | 60-65 |
| TS-610 | Dimethyldichlorosilane | 120 | 30-40 |
| TS-720 | Polydimethyl siloxane | 100 | 70-75 |
| M-5 | untreated | 200 | Hydrophilic |
| HS-5 | untreated | 325 | Hydrophilic |

TABLE 5

| | Aerogel | Fumed | Fibers | Rutile | SiC | ATH | Surfactant |
|---|---|---|---|---|---|---|---|
| Example | (g) | Silica (g) | (g) | sand (g) | (g) | (g) | (g) |
| 5-1 | 7.61 | 0.84 | 8.45 | 1.53 | 1.53 | 0.49 | 1.95 |
| 5-2* | 7.61 | 0.84 | 9.29 | 1.53 | 1.53 | 0.49 | 1.95 |
| 5-3 | 7.61 | 0.84 | 8.45 | 1.53 | 1.53 | 0.49 | 1.95 |
| 5-4 | 7.61 | 0.84 | 8.45 | 1.53 | 1.53 | 0.49 | 1.95 |
| 5-5* | 7.61 | 0.84 | 8.45 | 1.53 | 1.53 | 0.49 | 1.95 |
| 5-6* | 7.61 | 0.84 | 8.45 | 1.53 | 1.53 | 0.49 | 1.95 |

| | Rheology | Defoamer | Acrylic | Silicone | |
|---|---|---|---|---|---|
| Example | Modifier (g) | (g) | Binder (g) | Binder (g) | Flocculant(g) |
| 5-1 | 2.2 | 4.45 | 0.27 | 4.28 | 2.4 |
| 5-2* | 2.2 | 1.95 | 0.27 | 4.28 | 2.9 |
| 5-3 | 2.2 | 1.95 | 0.27 | 4.28 | 2.6 |
| 5-4 | 2.2 | 1.95 | 0.27 | 4.28 | 2.4 |
| 5-5* | 2.2 | 1.95 | 0.27 | 4.28 | 2.6 |
| 5-6* | 2.2 | 1.95 | 0.27 | 4.28 | 2.8 |

*Comparative example

TABLE 6

| | | Thermal | | |
|---|---|---|---|---|
| | | Conductivity | Thickness | UL94 |
| Example | Silica Type | (mW/m · K) | (mm) | rating |
| 5-1 | TS-530 | 25.1 | 1.98 | V0 |
| 5-2* | None | 26.0 | 2.13 | V0 |
| 5-3 | TS-610 | 24.9 | 2.10 | V0 |
| 5-4 | TS-720 | 23.7 | 1.98 | V0 |
| 5-5* | M-5 | 25.0 | 1.90 | V0 |
| 5-6* | HS-5 | 25.4 | 1.87 | V0 |

### Example 6

Blankets are produced as described in Example 5 using CAB-O-SIL TG-6110G silica having a BET surface area of about 86 m²/g, D50 of 9 microns, and methanol wettability of 65-70 with trimethylsilyl groups at the surface and CAB-O-SIL TG5180 silica, having a BET surface area of about 35 m²/g, D50 between 5 and 40 microns, and methanol wettability greater than 70 and a surface treatment of polydimethylsiloxane. The resulting blankets are expected to have a thermal conductivity between 20 and 30 and to have a UL94 rating of V0.

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A heat control member comprising a mixture of a) silica aerogel particles having particle sizes in a range from 0.1 mm to 5 mm and b) hydrophobic silica-containing particles having a methanol number of at least 30 and a particle size D50 of 100 microns or less, the mixture having a particle size distribution of silica-containing particles having at least two peaks,
wherein the silica aerogel particles and hydrophobic silica containing particles are present in a ratio from 1:99 to 99:1; and
wherein the heat control member has a thermal conductivity at 25° C. of approximately 5-30 mW/m.K and a thickness of 0.1-10 mm.

2. The heat control member of claim 1, wherein the hydrophobic silica-containing particles are selected from the group consisting of silica aerogel, fumed silica, silicon-treated carbon black, silica-coated carbon black, fumed mixed metal oxides, precipitated silica, silica-carbon black composite particles, rice husk silica, and sol-gel silica.

3. The heat control member of claim 1, wherein the hydrophobic silica-containing particles are selected from the group consisting of silica aerogel, fumed silica, precipitated silica, and sol-gel silica.

4. The heat control member of claim 1, wherein the hydrophobic silica-containing particles are hydrophobized by a silicone fluid, a cyclic siloxane, a hydrophobizing silane, a functionalized silane, or a silazane.

5. The heat control member of claim 1, wherein the hydrophobic silica-containing particles are hydrophobic fumed silica particles having a surface area from 30 to 550 m²/g, preferably from 30 to 250 m²/g.

6. The heat control member of claim 1, wherein the hydrophobizing silane is: R₄₋ₙSiXₙ wherein n is 1-3, each R is independently selected from the group consisting of hydrogen, a C1-C30 branched and straight chain alkyl or alkenyl group, a C3-C18 haloalkyl group, C3-C10 cycloalkyl, and a C6-C14 aromatic group, and each X is independently a C1-C18 branched or straight chain alkoxy group or halo.

7. The heat control member of claim 1, wherein the functionalized silane comprises at least one functional group selected from the group consisting of acrylate, methacrylate, amino, anhydride, epoxy, halogen, hydroxyl, sulfur, vinyl, isocyanate, and combinations thereof.

8. The heat control member of claim 1, wherein the particle size D50 of the hydrophobic silica-containing particle is from 0.1 microns to 100 microns.

9. The heat control member of claim 1, wherein the mixture further comprises fibers.

10. The heat control member of claim 1, wherein the fibers are glass fibers, ceramic fibers, synthetic polymer fibers, carbon fiber, natural polymer fibers, mineral wool, or a mixture of two or more of these.

11. The heat control member of claim 1, wherein the fibers are blackened or coated with a metal.

12. The heat control member of claim 1, wherein at least a portion of the silica aerogel present in the heat control member incorporates an opacifier.

13. The heat control member of claim 1, wherein at least a portion of the silica aerogel is coated with or impregnated with a heat absorbing material.

14. The heat control member of claim 1, wherein the mixture further comprises one or more components selected from the group consisting of fiber, opacifier, fire retardant, heat absorbing material, phase change material, binder, defoamer, dispersant, emulsifier, surfactant, and flocculant.

15. The heat control member of claim 1, further comprising a sheet or mat comprising silicone, polyvinylidene fluoride, chlorinated polyethylene, aramid fibers, or aramid aerogel.

16. The heat control member of claim 1, further comprising an envelope encapsulating the mixture.

17. The heat control member of claim 1, wherein the heat control member is in the form of a blanket or pressed pad.

18. The heat control member of claim 1, wherein the heat control member meets the specifications of UL94 V0.
